(19) United States
(12) Patent Application Publication
(10) Pub. No.: US 2012/0017810 A1
(43) Pub. Date: Jan. 26, 2012

(54) ARTICLE OF FURNITURE

(75) Inventor: Gregory Brent Welsh, Beverley Park (AU)

(73) Assignee: SEBEL FURNITURE LTD, Padstow (AU)

(21) Appl. No.: 13/256,689

(22) PCT Filed: Mar. 16, 2010
(86) PCT No.: PCT/AU2010/000296

§ 371 Date: Sep. 30, 2011

(30) Foreign Application Priority Data
Apr. 16, 2009 (AU) 2009901605

(51) Int. Cl. A47B 41/02; B23P 17/00; A47B 13/08

(52) U.S. Cl. 108/161; 29/527.1

(57) ABSTRACT

A school desk top or table top (31) is disclosed having a buffer (37, 47) extending around its perpendicular side edge and formed by injection moulding. The front edge (42, 52) and rear edge (43, 53) of the desk have a curved buffer (37) to avoid a sharp edge on which a student's forearm might rest. However, the side edges (41, 54) have a substantially flat buffer (47) to enable two like desks (40, 50) to be edge abutted and thereby provide a substantially continuous flat working surface.

### FIELD OF THE INVENTION

The present invention relates to furniture and, in particular, to furniture having a planar substrate such as the working surface of a desk. The invention is particularly applicable to school desks, however, the invention is not restricted thereto.

### BACKGROUND ART

Class room furniture, such as school desks, constitutes a very demanding segment of the overall furniture market in that such articles of furniture must be inexpensive in order to be able to be purchased in large numbers by educational institutions. Yet such furniture must be very hard wearing, particularly in terms of resisting attack of various kinds from students who have no particular love of their school furniture.

It is desirable in providing a working substrate such a table top or desk top to avoid sharp edges and to provide curved surfaces wherever possible. In particular, those edges against which a user is liable to rest an arm in the course of sitting or working at the desk or table should not have a sharp edge. Thus many tables, and circular tables in particular, have a curved edge profile, which is sometimes referred to as a bull nose profile.

However, a particular requirement of school desks is that the edge of the desk top which faces the torso of a student sitting at the desk (and which is conveniently referred to as the rear edge of the desk) should be curved or bevelled so as not to produce a sharp edge against which the underside of the forearms of the student can come into contact. However, in many classrooms situations it is desirable to be able to edge abut adjacent desks and thereby form a row. Thus the left and right side edges of the desk top should be substantially vertical so as to permit the edge abutment to take place without creating a valley or groove between adjacent desk top surfaces. Generally the front edge of the desk is not critical as to its profile, save that it is generally desirable for the front edge to avoid sharp edges.

It is possible to create such shaped or curved edges from planar wooden substrates by means of routing, for example. However, for cost reasons the wooden substrate is normally fabricated from a “board” formed by timber particles which are glued together or formed from multiple plies of thin veneer such as 5 ply or 10 ply. Under these circumstances, routing of the edge provides a very weak surface relative to the upper (and generally also lower) surfaces which can be laminated with a plastic hardwearing veneer such as those sold under the names FORMICA or LAMINEX (Registered Trade Marks).

In recent years, it has been in the practice to provide the edges of such wooden desk tops with a plastics buffer or bead which extends around the edge and substantially strengthens the edge against damage, particularly chipping or splitting of the edge. Such plastic buffers have been secured to the edges of the desk top by means of a friction fit or by means of gluing.

### GENESIS OF THE INVENTION

The genesis of the present invention is a desire to provide an article of furniture such as a school desk with a desk top having such a bead or buffer. The desk top is preferably able to have a different profile on adjacent edges so that, for example, school desks can be edge abutted as described above but still have no sharp edges on the rear edge of the desk top.

### SUMMARY OF THE INVENTION

In accordance with a first aspect of the present invention there is disclosed an article of furniture having a substantially planar substrate with at least one edge, said at least one edge being coated with an elongate layer of plastics material to form a buffer which extends along said edge, wherein said plastics layer is formed on said substrate by an injection moulding process and wherein said substrate has a surface adjoining said coating layer which is curved when viewed in a cross-section which is transverse to the longitudinal axis of said buffer.

Preferably the exterior of the buffer is curved when viewed in the transverse cross-section.

Preferably the substrate has first and second adjacent edges which are substantially perpendicular to each other, said buffer extends along both said edges, said substrate first edge and the exterior surface of said buffer adjacent said first edge are curved, but the exterior surface of said buffer adjacent said second edge is substantially flat, whereby two like said articles of furniture can have their substrates edge abutted by edge abutting said buffers adjacent said second edges.

Preferably the substrate second edge is substantially flat when viewed in the transverse cross-section.

In accordance with a second aspect of the present invention there is disclosed a method of forming an article of furniture having a buffer, said method comprising the steps of:

(i) forming at least one edge of a substantially planar substrate, along which said buffer is to extend, to have a substantially curved surface when viewed in the direction of a cross-section taken transverse to the longitudinal axis of said buffer, and

(ii) injection moulding said buffer to said curved edge.

### BRIEF DESCRIPTION OF THE DRAWINGS

A preferred embodiment of the invention will now be described, by way of example only, with reference to the accompanying drawings in which:

FIG. 1 is a transverse cross-sectional view through a desk top and edge beading of a first form of prior art,

FIG. 2 is a view similar to FIG. 1 but of a second form of prior art,

FIG. 3 is a view similar to FIGS. 1 and 2 but of a first embodiment of the present invention taken along the line III-III of FIG. 6,

FIG. 4 is a view similar to FIG. 3 but taken along the lines IV-IV of FIG. 6,

FIG. 5 is a view similar to FIG. 4 but of another embodiment;

FIG. 6 is an exploded perspective view from above showing the right hand side edge of a left desk being edge abutted against the left hand side edge of a right desk, the working surfaces of both desks being illustrated in transparent fashion, and

FIGS. 7A-7C are plan views of various different desk and table tops.

### DETAILED DESCRIPTION

As seen in FIG. 1 a prior art table top 1 or desk working surface, is viewed in cross-section and has a upper surface 2 and a lower surface 3. A side edge 5 of the table top is illustrated and is flat in the cross-sectional view illustrated in FIG. 1. If the table top 1 is circular then there is only one side edge 5 and it is essentially cylindrical. If the table top 1 is rectangular then there are four side edges 5 the adjacent ones of which are substantially perpendicular and intersect to form the four corners (not illustrated) of the table top 1.

As illustrated in FIG. 1 the side edge 5 is provided with a continuous groove 6 which extends along the side edge 5. A side bead 7 is formed with a stem 8 which protrudes from a flat inner surface 9. The side bead has a outer surface which can be curved as indicated at 11 or can be flat as indicated at 12. The free end of the stem 8 is provided with a barbed head 13.

In order to attach the side bead 7 to the table top 1, the stem 8 is forced into the groove 6 thereby compressing the barbed head 13 and providing a good frictional fit between the side bead 7 and the table top 1. Normally no glue is used, however, this can be provided if desired.

The table top 1 with its side bead 7 suffers from a number of disadvantages, one of which is that students provided with a school desk having such an arrangement are liable to introduce a knife or screwdriver into the crack formed between the table top 1 and the flat inner surface 9 so as to prise the side bead 7 away from the table top 1.

Turning now to FIG. 2, illustrated therein is a table top 21 having an upper and lower surface 22 and 23 respectively and a side bead 27 of rectangular cross-section which abuts a flat side edge 25 of the table top 21. In one form of the prior art arrangement illustrated in FIG. 2 the side bead 27 is extruded as a rectangular strip of plastics material and then adhered to the side edge 25. In another form of the prior art illustrated in FIG. 2 the side bead 27 is injection moulded directly onto the side edge 25 by placing the table top 21 into the mould used to form the injection moulded side bead 27.

A weakness of the arrangements of FIGS. 1 and 2 where the side bead 27 is formed from an extruded strip, is that the ends of the strip must be joined together. This join represents a line of weakness which may be attacked by students of a malicious disposition. This problem is overcome by the abovementioned prior art arrangement of injection moulding the side bead 27.

Where the table top 21 is circular, then the side edge 25 is cylindrical and so too is the side bead 27. However, where the table top 21 is rectangular the side bead 27 extends around the four corners and the table top 21 may be abutted with a like table top 21 because of the flat nature of the side bead 27. However, the edge of the table top 21 formed by the upper edge 28 of the side bead 27, even if slightly bevelled, forms a relatively sharp edge against which the under side of a forearm of a student or other person sitting at a table having the table top 21, comes into contact. It would therefore be desirable to remove the sharp edge if possible.

A first embodiment of the present invention is illustrated in FIGS. 3, 4 and 6. As seen in FIG. 3, a desk top 31 is provided with upper and lower surfaces 32, 33 respectively which are preferably formed from a tough durable laminate such as that sold under the Registered Trade Marks FORMICA and LAMINEX.

One edge of the desk top 31 is provided with a buffer 37 having a generally parabolic or bull nose profile which does not present any sharp edge to the user. Prior to creation of the buffer 37, the side edge 35 of the table top 31 is routed so as to form the curved profile illustrated in FIG. 3 having two steps or discontinuities 36. The buffer 37 is preferably formed from polypropylene by injection moulding the buffer 37 in a mould in which the desk top 31 has been positioned. In this way the outer surface of the buffer 37 can be formed flush with the upper and lower surfaces 32, 33 and excellent adhesion between the buffer 37 and the side edge 35 is obtained.

The other side edge of the desk top 31 is illustrated in FIG. 4 and is provided with an injection moulded substantially flat buffer 47 which is joined to a substantially flat edge 48.

Preferably the buffer 47 has an extended underside 74 which is substantially flush with the underside 33 of the desk 31. The underside 74 is formed by filling with plastic, during the injection moulding process, a rebate which is routed out of the desk top 31. Such an underside extension 74 is particularly useful for strengthening particularly the corners of desks and tables with folding legs. Such desks with folding legs are used at examination time, are stored away when not required, and can be subject to particularly abusive behaviour because of their light weight. Because the legs fold into a space within the perimeter of the desktop, it is the edges of the desk top which bear the brunt of this abuse.

The interior of the table top 31 is preferably formed from particle board which takes the form of small timber particles adhered together in a glue-like matrix. This is inexpensive but does not present an attractive surface. Thus all surfaces are covered by means of the laminates 32, 33 and the buffers 37, 47.

Turning now to FIG. 6, two desks 40 and 50 are illustrated in FIG. 6 with the top of each desk being illustrated in transparent fashion. In FIG. 6 the left hand desk 40 has a right hand side edge 41 as well as a front edge 42 and rear edge 43. The left hand side edge of the desk 40 is not visible in FIG. 6. Also illustrated in FIG. 6 is the right hand leg 46 of the desk 40.

Turning now to the desk 50, part of its front edge 52 and part of its rear edge 53 are visible, as is the upper edge of its left hand side edge 54. The right hand side edge of the desk 50 is also visible.

It will be apparent from FIG. 6 that the side edges 41, 54 with their buffer 47 are flat and can therefore be edge abutted as indicated by means of arrows A and B in FIG. 6. When so abutted the tops 31 of the desks 40 and 50 are substantially flush and provide a substantially continuous working surface.

However, the front edges 42, 52 and rear edges 43, 53 are provided with the curved buffer 37 and thus do not have any sharp edges. In this way a comfortable surface for the forearms of students sitting at the desks 40 and 50 is presented.

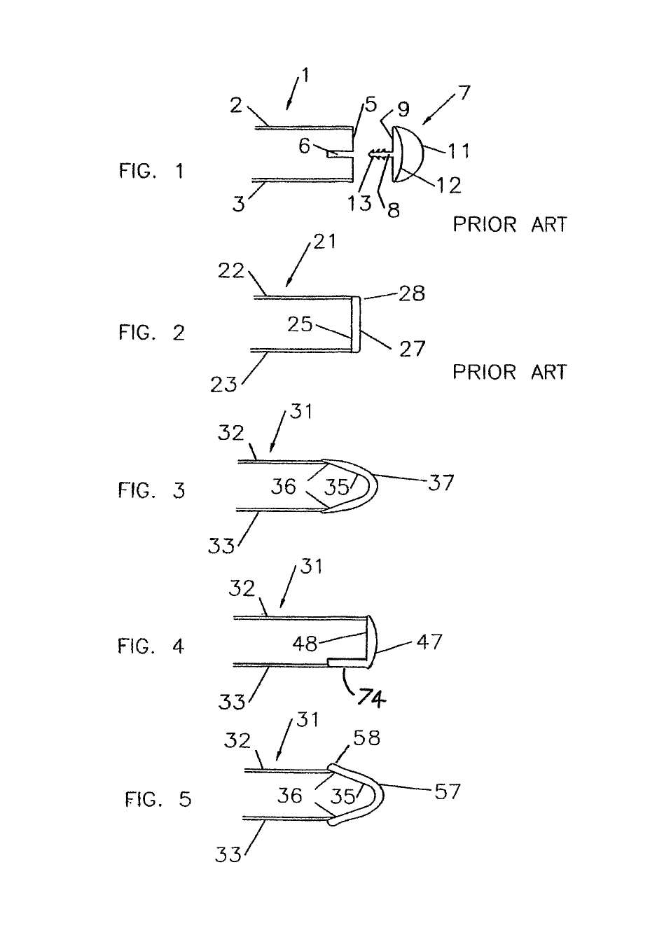

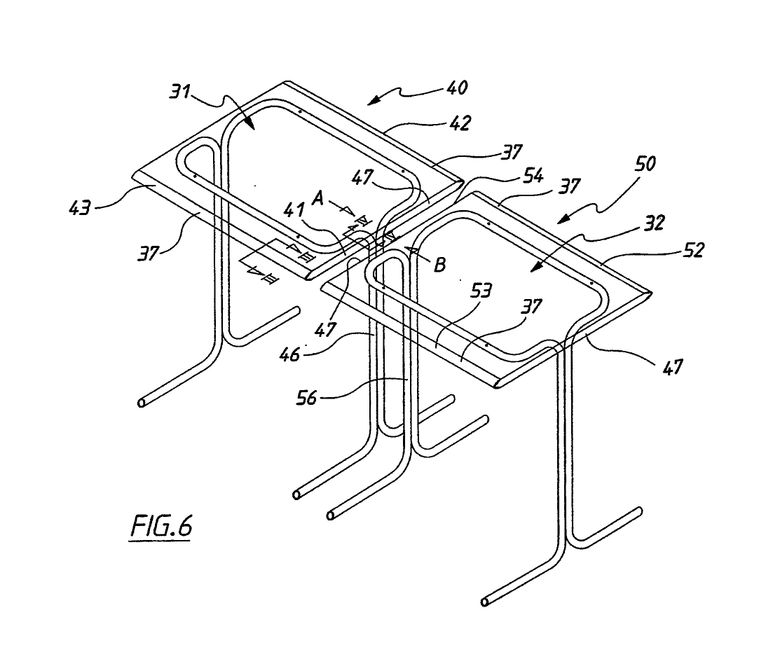

Turning now to FIG. 5, another profile is illustrated having a buffer 57 with a lip 58 which is proud of the upper surface 32 and can thus function as a moisture or spill trap which is useful for scientific bench tops, for example.

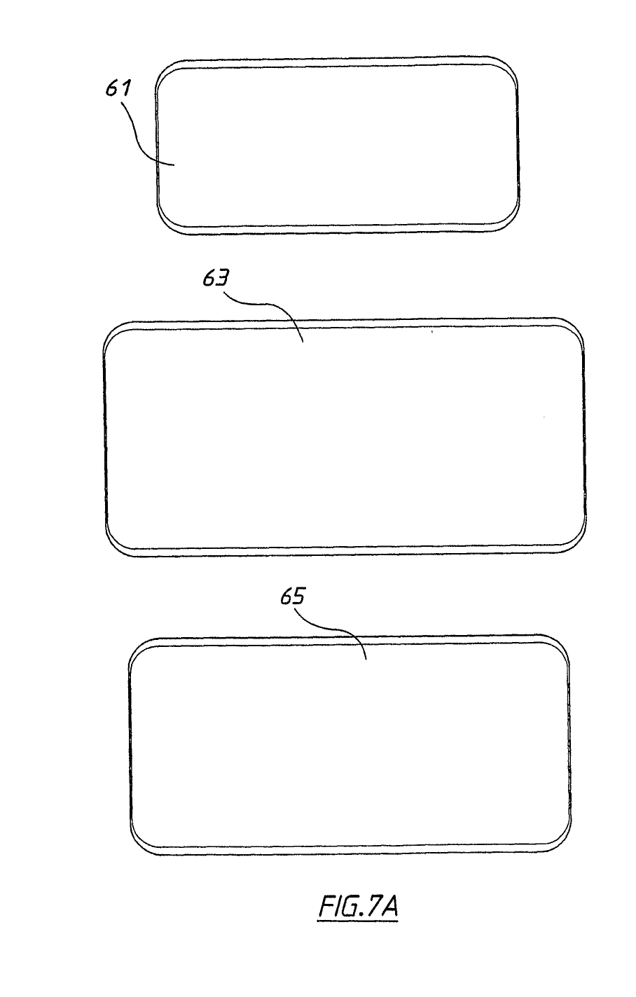

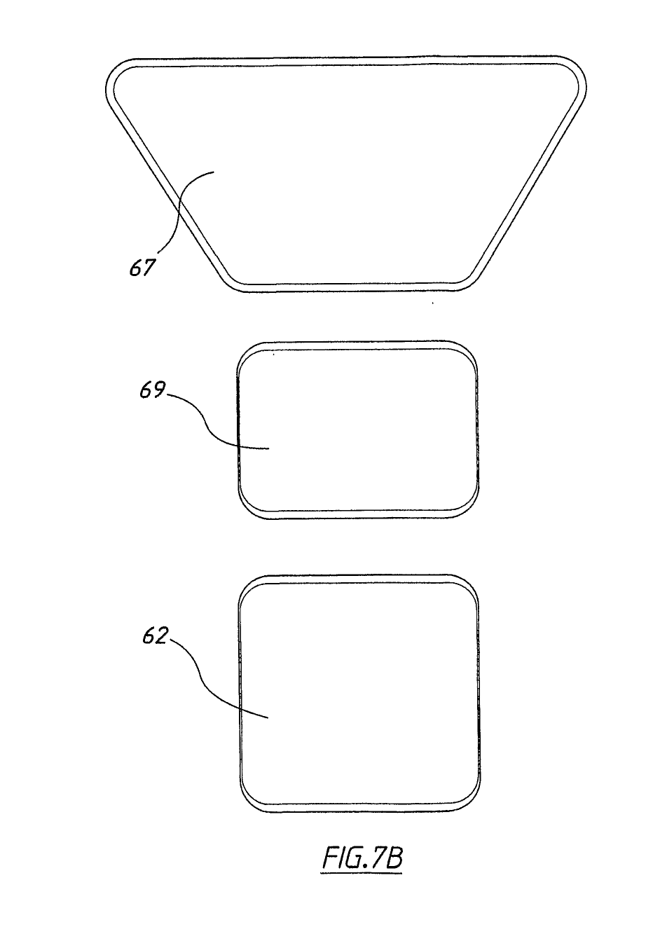

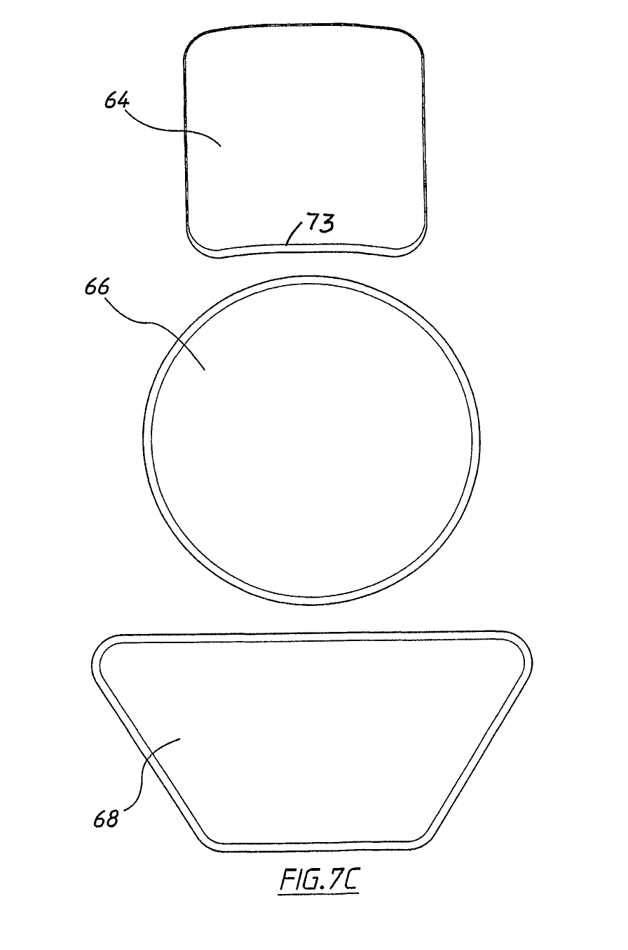

As seen in FIGS. 7A-7C various table and desk tops 61-69 are illustrated in plan view. Tops 61, 63, 65 and 69 are rectangular, top 62 is square, tops 67 and 68 are trapezoidal and top 66 is circular. Top 64 is substantially square but is provided with an indented edge 73 which is recessed when viewed in plan to partially accommodate the torso of a person sitting at the desk or table with such a top 64.

The foregoing describes only some embodiments of the present invention and modifications, obvious to those skilled in the furniture arts, can be made thereto without departing from the scope of the present invention.

The term “comprising” (and its grammatical variations) as used herein is used in the inclusive sense of “including” or “having” and not in the exclusive sense of “consisting only of”.

1. An article of furniture having a substantially planar substrate with at least one edge, said at least one edge being coated with an elongate layer of plastics material to form a buffer which extends along said edge, wherein said plastics layer is formed on said substrate by an injection moulding process and wherein said substrate has a surface adjoining said coating layer which is curved when viewed in a cross-section which is transverse to the longitudinal axis of said buffer.

2. The article of furniture as claimed in claim 1 wherein the exterior surface of said buffer is curved when viewed in said transverse cross-section.

3. The article of furniture as claimed in claim 2 wherein said substrate has first and second adjacent edges which are substantially perpendicular to each other, said buffer extends along both said edges, said substrate first edge and the exterior surface of said buffer adjacent said first edge are curved, but the exterior surface of said buffer adjacent said second edge is substantially flat, whereby two like said articles of furniture can have their substrates edge abutted by edge abutting said buffers adjacent said second edges.

4. The article of furniture as claimed in claim 3 wherein said substrate second edge is substantially flat when viewed in said transverse cross-section.

5. The article of furniture as claimed in claim 1 and comprising a school desk.

6. The article of furniture as claimed in claim 5 wherein said substrate comprises a laminated wooden board.

7. The article of furniture as claimed in claim 6 where said curved substrate edge is formed by routing.

8. The article of furniture as claimed in claim 1, wherein said buffer is fabricated form polypropylene.

9. The article of furniture as claimed in claim 1, wherein a step-like discontinuity forms the boundary between said curved edge and a planar surface of said substrate.

10. The article of furniture as claimed in claim 1, wherein said buffer is proud of an upper surface of said substrate to thereby form a moisture or spill trap.

11. The article of furniture as claimed in claim 1, wherein said buffer has an extension which extends away from said one edge on an underside of said substrate and substantially flush with said underside.

12. A method of forming an article of furniture having a buffer, said method comprising the steps of:
(i) forming at least one edge of a substantially planar substrate, along which said buffer is to extend, to have a substantially curved surface when viewed in the direction of a cross-section taken transverse to the longitudinal axis of said buffer, and
(ii) injection moulding said buffer to said curved edge.

13. The method as claimed in claim 12 including the further steps of:
a. forming said planar substrate with at least two substantially perpendicular edges, and
b. forming said buffer along both said edges and with the cross-sectional shape of said buffer formed on said one edge being different from the shape of said buffer formed on the other edge.

14. The method as claimed in claim 11 including the further step of forming an extension of said buffer which extends away from said one edge and which is substantially flush with a lower surface of said substrate.
